(19) United States
(12) Patent Application Publication
(10) Pub. No.: US 2025/0050479 A1
(43) Pub. Date: Feb. 13, 2025

(54) HYDRAULIC POWER TOOL

(71) Applicant: MILWAUKEE ELECTRIC TOOL CORPORATION, Brookfield, WI (US)

(72) Inventor: Matthew Jensen, Milwaukee, WI (US)

(21) Appl. No.: 18/796,510

(22) Filed: Aug. 7, 2024

Related U.S. Application Data
(60) Provisional application No. 63/518,496, filed on Aug. 9, 2023.

(51) Int. Cl. B25B 27/02; B21D 39/04; B25B 27/10

(52) U.S. Cl. CPC B25B 27/026; B21D 39/046; B25B 27/10

(57) ABSTRACT

A crimping head includes a clevis having a first arm and second arm defining a gap therebetween in which a workpiece is positioned and a nest. The crimping head further includes a first sleeve received within a first bore in the first arm and a second sleeve received within a second bore in the second arm. The first pin is received in the first sleeve for relative rotation therewith and the second pin is selectively received within the second sleeve. The hardness of the first and second sleeves is greater than the hardness of the clevis.

### CROSS-REFERENCE TO RELATED APPLICATIONS

This application claims priority to U.S. Provisional Patent Application No. 63/518,496, filed Aug. 9, 2023, the entire content of which is incorporated herein by reference.

### FIELD OF THE INVENTION

The present invention relates to power tools, and more particularly to hand-held hydraulic power tools.

### BACKGROUND OF THE INVENTION

Hydraulic crimpers and cutters are different types of hydraulic power tools for performing work (e.g., crimping or cutting) on a workpiece. In such tools, a hydraulic pump is utilized for pressurizing hydraulic fluid and transferring it to a cylinder in the tool, causing an extensible piston to be displaced. The piston exerts a force on the head of the power tool, which may include opposed jaws with crimping or cutting features, depending upon the particular configuration of the power tool. In this case, the force exerted by the piston may be used for closing the jaws to perform work on a workpiece.

### SUMMARY OF THE INVENTION

The invention provides, in one aspect, a crimping head that includes a clevis having a first arm and second arm defining a gap therebetween in which a workpiece to be crimped is positioned. The crimping head also includes a nest having a first end pivotably coupled to the first arm to the clevis with a first pin and an opposite, second end selectively coupled to the second arm of the clevis with a second pin to rigidly affix the nest to the clevis. The crimping head further includes a first sleeve received within a first bore in the first arm and a second sleeve received within a second bore in the second arm. The first pin is received in the first sleeve for relative rotation therewith and the second pin is selectively received within the second sleeve. The hardness of the first and second sleeves is greater than the hardness of the clevis.

In another independent aspect, the present invention provides a hydraulic power tool that includes a hydraulic power unit and a crimping head coupled to the hydraulic power unit. The crimping head further includes a clevis having a first arm and second arm defining a gap therebetween in which a workpiece to be crimped is positioned. The crimping head also includes a nest having a first end pivotably coupled to the first arm to the clevis with a first pin and an opposite, second end selectively coupled to the second arm of the clevis with a second pin to rigidly affix the nest to the clevis. The crimping head further includes a first sleeve received within a first bore in the first arm and a second sleeve received within a second bore in the second arm. The first pin is received in the first sleeve for relative rotation therewith and the second pin is selectively received within the second sleeve. The hardness of the first and second sleeves is greater than the hardness of the clevis.

In another independent aspect, the present invention provides a hydraulic power tool that includes a hydraulic power unit and a crimping head coupled to the hydraulic power unit. The crimping head further includes a clevis having a first arm and second arm defining a gap therebetween in which a workpiece to be crimped is positioned. The crimping head also includes a nest having a first end pivotably coupled to the first arm to the clevis with a first pin and an opposite, second end selectively coupled to the second arm of the clevis with a second pin to rigidly affix the nest to the clevis. The crimping head further includes a first sleeve, a second sleeve, a third sleeve, and a fourth sleeve. The first pin is received in the first sleeve and the third sleeve for relative rotation therewith. The second pin is slidably received within the second sleeve and the fourth sleeve. The hardness of the first, second, third, and fourth sleeves is greater than the hardness of the clevis.

Other features and aspects of the invention will become apparent by consideration of the detailed description and accompanying drawings.

### BRIEF DESCRIPTION OF THE DRAWINGS

FIG. 1 is a side view of a hydraulic power tool in accordance with an embodiment of the invention.

FIG. 2 is an enlarged perspective view of a crimping head of the hydraulic power tool of FIG. 1.

FIG. 3 is a cross-sectional view of a portion of the crimping head in FIG. 2 through section 3-3 in FIG. 2.

FIG. 4 is a cross-sectional view of the crimping head of FIG. 2 through section 4-4 in FIG. 2.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

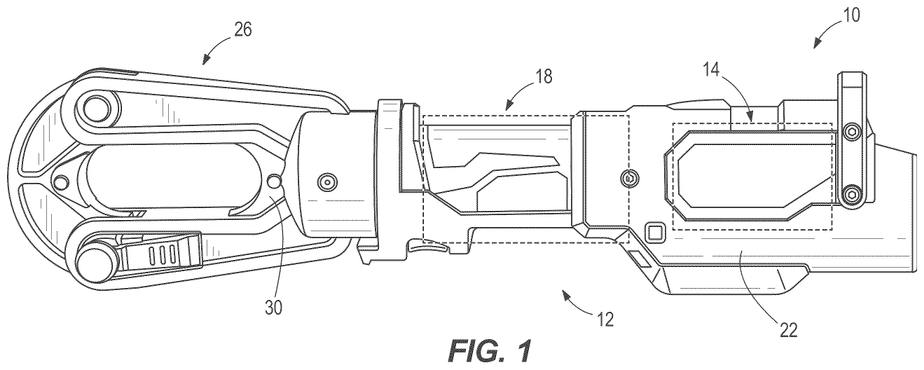

FIG. 1 illustrates an embodiment of a hydraulic crimper 10 including a housing 22, a crimping head 26 extending from the housing 22, and a hydraulic power unit 12 configured to operate the crimping head 26. The hydraulic power unit 12 includes an electric motor 14 and a hydraulic pump 18 driven by the motor 14 to provide pressurized hydraulic fluid to extend a ram 30 which, when a workpiece (e.g., a pipe or pipe fitting) is placed within the crimping head 26, is operable to perform a crimping operation on the workpiece. In some embodiments, the motor 14 receives electrical current from a removable battery pack (not shown) when attached to the housing 22. In some embodiments, the crimping head 26 may be rotatable about a portion of the ram 30. In some embodiments, the crimping head 26 may be removable or otherwise replaceable from housing 22 of the crimper 10. Although FIG. 1 illustrates a hydraulic crimper 10, the invention described herein may be applicable to a wide range of hydraulic power tools (e.g., cutters, knockout punches, etc.).

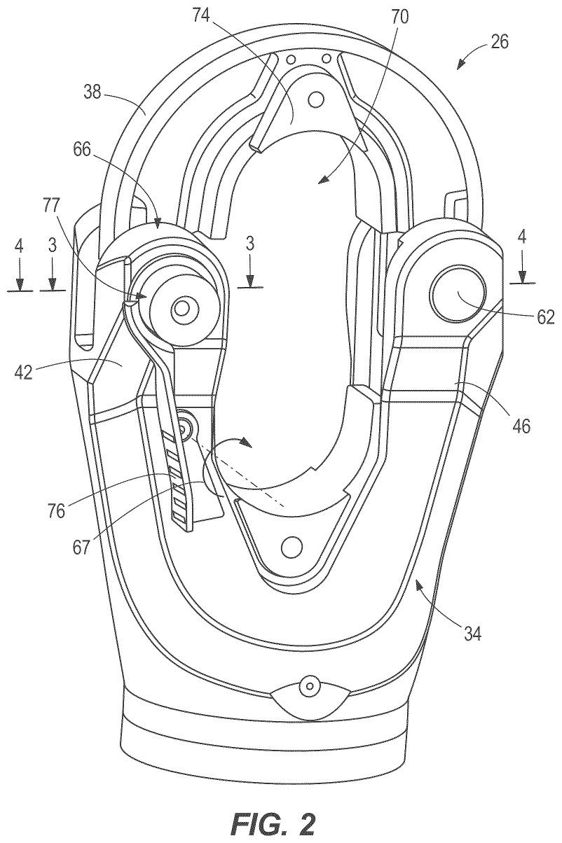

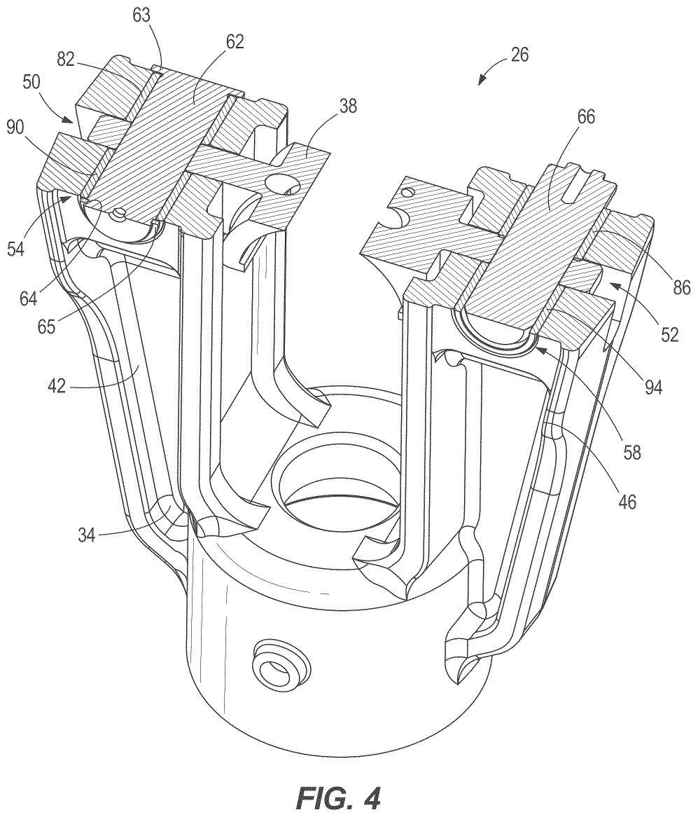

With reference to FIG. 2, the crimping head 26 includes a clevis 34 extending from the housing 22 and a nest 38. The clevis 34 surrounds a portion of the workpiece when positioned therein and supports the nest 38. The clevis 34 includes a first arm 42 and a second arm 46 and defines a gap therebetween through which the ram 30 travels. Each arm 42, 46 includes a slot and a bore, with the first arm 42 having a first bore 54 and the second arm 46 having a second bore 58 (FIG. 4). More specifically, the first arm 42 includes a first slot 50 to receive one end of the nest 38 and a first bore 54 oriented perpendicular to the slot 50. A pivot pin 62 is inserted through the first bore 54, the slot 50, and a corresponding hole in the nest 38, thereby securing the nest 38 to the clevis 34. The second arm 46 includes a second slot 52 to receive an opposite end of the nest 38 and a second bore 58 oriented perpendicular to the second slot 52. A quick-release pin 66 is inserted through the second bore 58, the slot 52, and a corresponding hole in the nest 38, thereby securing the nest 38 to the clevis 34. Said another way, the quick-release pin 66 is selectively couplable to the nest 38, and accordingly may rigidly affix the nest 38 to the clevis 34.

In some embodiments, the nest 38 is configured to receive and support a stationary die (not shown) and a movable die (also not shown) is attached to the ram 30. A workpiece (e.g., a pipe or pipe fitting) is positioned within a cavity 70 defined between the dies which, during a crimping operation, compress and deform the workpiece. When the quick-release pin 66 is removed from the clevis 34, the nest 38 is pivotable from a closed position (shown in FIG. 2) to an open position by pivoting the nest 38 about the pivot pin 62 to remove the crimped workpiece and replace it with a new workpiece to be crimped. Then, the nest 38 is returned to the closed position and the quick-release pin 66 replaced into the second bore 58, locking the nest 38 into the closed position shown in FIG. 2 for a subsequent crimping operation on a workpiece.

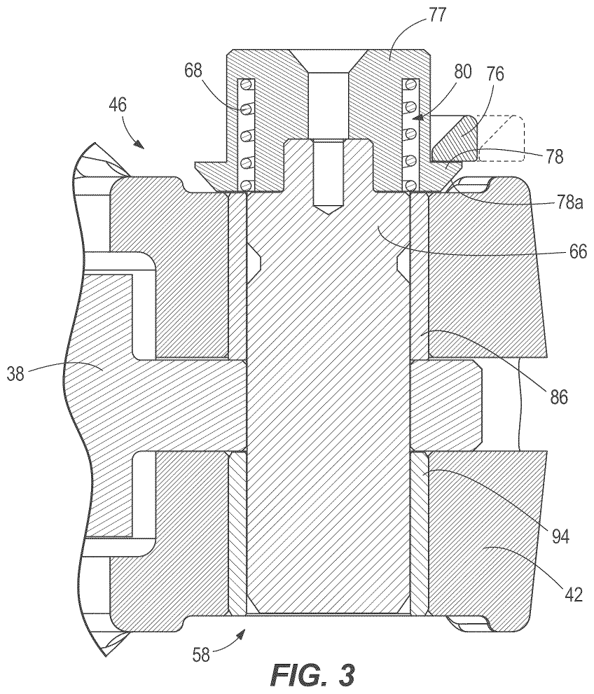

To secure the quick-release pin 66 to the clevis 34, a quick-release latch 76 is pivotable between a locked position (shown in FIG. 2), where the latch 76 holds the quick-release pin 66 within the second bore 58, and a release position, where the quick-release pin 66 is removable form the second bore 58 to permit the nest 38 to be pivoted to the open position. To hold the quick-release pin 66 in the retracted position, the latch 76 engages a cap 77 (FIGS. 2 and 3) fixed to one end of the quick-release pin 66, thereby selectively locking the quick-release pin 66 within the second bore 58. More specifically, the cap 77 includes a radially outward extending flange 78 against which the latch 76 is engaged (FIG. 3) to thereby maintain the quick-release pin 66 within the second bore 58. In some embodiments, the latch 76 is pivotably coupled to the clevis 34, which may include a biasing member (e.g., a torsion spring 67 to bias the latch 76 towards the locked position. To release the quick-release pin 66, the latch 76 is pivoted away from the quick-release pin 66, releasing the cap 77 and allowing the quick-release pin 66 to be removed from the second bore 58. Upon the latch 76 being pivoted into the release position, a compression spring 68 disposed in a spring cavity 80 between the cap 77 and the clevis 34 biases the quick-release pin 66 to move out of the second bore 58 and disengage the nest 38. With continued reference to FIG. 3, the cap flange 78 includes a tapered end 78a with which the latch 76 is engageable during insertion of the quick-release pin 66 into the second bore 58 while the latch 76 is in the locked position. After the tapered end 78a of the cap flange 78 initially abuts the latch 76, further insertion of the quick-release pin 66 into the second bore 58 causes the latch 76 to automatically pivot from the locked position toward the release position. When the latch 76 clears the cap flange 78, the latch 76 is automatically pivoted back to the locked position shown in FIG. 3 to secure the cap 77 against the clevis 34 and therefore, the quick-release pin 66 within the second bore 58.

As shown in FIG. 4, the pivot pin 62 rotatably couples the nest 38 to the clevis 34. In some embodiments, one end of the pivot pin 62 includes a radially outward extending flange 63 engaged with the first arm 42. At the opposite end, the pivot pin 62 includes a circumferential groove 64 configured to receive a retaining clip 65. Collectively, the flange 63 and the retaining clip restrict the axial movement of the pivot pin 62, and thus retain the pivot pin 62 within the first bore 54 at all times.

With continued reference to FIG. 4, the pivot pin 62 is rotatable within the first bore 54 when the nest 38 is moved from the closed position to the open position. Over time, this rotation may result in wear between the pivot pin 62 and the clevis 34. To prevent this, a first sleeve 82 is disposed between the clevis 34 and the pivot pin 62, allowing the pivot pin 62 to rotate therewith without contacting and thus imparting wear to the clevis 34. Additionally, a second sleeve 86 is disposed between the clevis 34 and the quick-release pin 66. The quick-release pin 66 slides to an extended position and a retracted position to allow the nest 38 to move between the open position and closed position. In other words, the quick-release pin 66 moves back and forth within the clevis 34 every time a workpiece is inserted and removed. Accordingly, the second sleeve 86 allows the quick-release pin 66 to slide within the second bore 58 without continuously rubbing against the clevis 34. In other words, the quick-release pin 66 is slidably received within the second sleeve 86.

In some embodiments, the first bore 54 may further include a third sleeve 90 disposed on one side of the slot 50 with the first sleeve 82 disposed on the opposite side of the slot 50. The second bore 58 may also include a fourth sleeve 94 disposed one side of the slot 52 with the second sleeve 86 disposed on the opposite side of the slot 52. In some embodiments, the sleeves 82, 86, 90, 94 are interference or press-fit within the corresponding bores 54, 58. In other embodiments, the sleeves 82, 86, 90, 94 may be removable from the corresponding bores 54, 58 and replaceable such that wear on the sleeves 82, 86, 90, 94 does not diminish the overall lifespan of the crimper 10. In some embodiments, the sleeves 82, 86, 90, 94 may include flanges (not shown) disposed between the nest 38 and the clevis 34.

Each of the sleeves 82, 86, 90, 94 is made from a harder material than the clevis 34. For example, in some embodiments, the sleeves 82, 86, 90, 94 are made from a relatively hard material like steel and the clevis 34 is made from a relatively soft and light material like Aluminum. As such, the Aluminum clevis 34, which is located at the front of the crimper 10, reduces the overall weight of the crimper 10 and shifts the center of gravity of the crimper 10 rearward and closer to the portion of the housing 22 grasped by an operator when using the crimper 10. However, the steel sleeves 82, 86, 90, 94 prevent any direct contact, and thus wear, between the pins 62, 66 and the clevis 34.

In some embodiments, the sleeves 82, 86, 90, 94 may be composed of the same material as the pivot pin 62, the quick-release pin 66, and the nest 38, which could reduce wear between those components. Additionally, the hardness of the sleeves 82, 86, 90, 94 may be greater than the hardness of the clevis 34. For example, in some embodiments, the clevis 34 may be composed of Aluminum, the sleeves 82, 86, 90, 94 may be composed of steel, the pins 62, 66 may be composed of steel, and the nest 38 may be composed of steel. In some embodiments, lubrication may be used between the sleeves 82, 86, 90, 94 and the pins 62, 66.

In some embodiments, a bearing may be used instead of the sleeves 82, 86, 90, 94 to facilitate the pivoting degree of freedom between the pin 66 and the clevis 34. In some embodiments, the surface of the clevis 34 surrounding the pins 60, 66 may be coated, potted, overmolded, or otherwise reinforced.

Although the invention has been described in detail with reference to certain preferred embodiments, variations and modifications exist within the scope and spirit of one or more independent aspects of the invention as described.

Various features of the invention are set forth in the following claims.

What is claimed is:

1. A crimping head coupled to a hydraulic power unit, the crimping head comprising:
a clevis having a first arm and a second arm defining a gap therebetween in which a workpiece to be crimped is positioned,
a nest having a first end pivotably coupled to the first arm with a first pin and an opposite, second end selectively coupled to the second arm with a second pin to rigidly affix the nest to the clevis,
a first sleeve received within a first bore in the first arm, the first pin being received within the first sleeve for relative rotation therewith, and
a second sleeve received within a second bore in the second arm, the second pin being selectively received within the second sleeve,
wherein a hardness of the first and second sleeves is greater than a hardness of the clevis.

2. The crimping head of claim 1, wherein the first pin includes a first end and an opposite, second end, wherein the first pin includes a radially outward extending flange at the first end engaged with the first arm, wherein the first pin includes a circumferential groove at the second end in which a retaining clip is received, and wherein the flange and retaining clip, collectively, axially retain the first pin within the first bore.

3. The crimping head of claim 1 further comprising a quick-release latch selectively locking the second pin within the second bore.

4. The crimping head of claim 3, wherein the quick-release latch is movable between a locked position, in which the second pin is axially retained within the second bore, and a release position, in which the second pin is removable from the second bore to permit the nest to pivot about the first pin away from the clevis.

5. The crimping head of claim 4, wherein the quick-release latch is pivotable between the locked position and the release position, and wherein the quick-release latch is biased towards the locked position.

6. The crimping head of claim 4 further comprising a spring biasing the second pin out of the second bore to facilitate removal of the second pin from the second bore when the quick-release latch is in the release position.

7. The crimping head of claim 1, wherein each of the first and second sleeves is made from steel, and wherein the clevis is made from Aluminum.

8. The crimping head of claim 7, wherein each of the first and second pins is made from steel.

9. A hydraulic power tool comprising:
a hydraulic power unit; and
a crimping head coupled to the hydraulic power unit, the crimping head including
a clevis having a first arm and a second arm defining a gap therebetween in which a workpiece to be crimped is positioned,
a nest having a first end pivotably coupled to the first arm with a first pin and an opposite, second end selectively coupled to the second arm with a second pin to rigidly affix the nest to the clevis,
a first sleeve received within a first bore in the first arm, the first pin being received within the first sleeve for relative rotation therewith, and
a second sleeve received within a second bore in the second arm, the second pin being selectively received within the second sleeve,
wherein a hardness of the first and second sleeves is greater than a hardness of the clevis.

10. The hydraulic power tool of claim 9, wherein the first pin includes a first end and an opposite, second end, wherein the first pin includes a radially outward extending flange at the first end engaged with the first arm, wherein the first pin includes a circumferential groove at the second end in which a retaining clip is received, and wherein the flange and retaining clip, collectively, axially retain the first pin within the first bore.

11. The hydraulic power tool of claim 9, wherein the crimping head further comprises a quick-release latch selectively locking the second pin within the second bore.

12. The hydraulic power tool of claim 11, wherein the quick-release latch is movable between a locked position, in which the second pin is axially retained within the second bore, and a release position, in which the second pin is removable from the second bore to permit the nest to pivot about the first pin away from the clevis.

13. The hydraulic power tool of claim 12, wherein the quick-release latch is pivotable between the locked position and the release position, and wherein the quick-release latch is biased towards the locked position.

14. The hydraulic power tool of claim 13, wherein the crimping head further comprises a spring biasing the second pin out of the second bore to facilitate removal of the second pin from the second bore when the quick-release latch is in the release position.

15. The hydraulic power tool of claim 9, wherein each of the first and second sleeves is made from steel, and wherein the clevis is made from Aluminum.

16. The hydraulic power tool of claim 15, wherein each of the first and second pins is made from steel.

17. The hydraulic power tool of claim 9, wherein the first sleeve is removably coupled to the first bore and the second sleeve is removably coupled to the second bore.

18. A hydraulic power tool comprising:
a hydraulic power unit; and
a crimping head coupled to the hydraulic power unit, the crimping head including
a clevis having a first arm and a second arm defining a gap therebetween in which a workpiece to be crimped is positioned,
a nest having a first end pivotably coupled to the first arm with a first pin and an opposite, second end selectively coupled to the second arm with a second pin to rigidly affix the nest to the clevis,
a first sleeve received within a first bore in the first arm,
a second sleeve received within a second bore in the second arm,
a third sleeve received within the first bore opposite the first sleeve, and
a fourth sleeve received within the second bore opposite the second sleeve,
wherein the first pin is received within both the first sleeve and the third sleeve for relative rotation therewith,
wherein the second pin is slidably received within both the second sleeve and the fourth sleeve, and
wherein a hardness of the first, second, third, and fourth sleeves is greater than a hardness of the clevis.

19. The hydraulic power tool of claim 18, wherein the clevis is made from Aluminum, and wherein each of the first pin, second pin, first sleeve, second sleeve, third sleeve, and fourth sleeve is made from steel.

20. The hydraulic power tool of claim 18, wherein the crimping head further comprises a quick-release latch selectively locking the second pin within the second bore, wherein the first pin includes a first end and an opposite, second end, wherein the first pin includes a radially outward extending flange at the first end engaged with the first arm, wherein the first pin includes a circumferential groove at the second end in which a retaining clip is received, and wherein the flange and retaining clip, collectively, axially retain the first pin within the first bore.
